(19) United States
(12) Patent Application Publication
(10) Pub. No.: US 2012/0053794 A1
(43) Pub. Date: Mar. 1, 2012

(54) INDIVIDUALIZABLE CONVENIENCE SYSTEM FOR DRIVERS

(75) Inventors: Javier A. Alcazar, Royal Oak, MI (US); Dorel M. Sala, Troy, MI (US); Jenne-Tai Wang, Rochester, MI (US)

(73) Assignee: GM GLOBAL TECHNOLOGY OPERATIONS, INC., Detroit, MI (US)

(21) Appl. No.: 12/868,388

(22) Filed: Aug. 25, 2010

(51) Int. Cl. G06F 7/00

(52) U.S. Cl. 701/48; 701/49

(57) ABSTRACT

A method and system for automatically adjusting a driver seat, steering wheel, pedals, mirrors, and other components of a vehicle, based on information about the size of the driver. The method uses basic information about the driver's size—including standing height, sitting height, and gender—in a model which estimates all anthropometric data for the driver. The anthropometric data for the driver—including upper and lower arm and leg lengths, torso length, and other dimensions—is used in inverse kinematic calculations to determine optimal positions and orientations for the adjustable components of the vehicle's cockpit. The method then pre-adjusts the components before the driver enters the vehicle, and makes compatible adjustments to the mirrors and other components if the driver adjusts the driver seat.

### BACKGROUND OF THE INVENTION

1. Field of the Invention

This invention relates generally to automatic adjustment of a vehicle driver seat and other components and, more particularly, to a method and system for automatically adjusting a driver seat, steering wheel, pedals, mirrors, and other components, which uses anthropometric data about the driver to determine optimal positions and orientations for the adjustable components, pre-adjusts the components when the driver enters the vehicle, and makes compatible adjustments to the other components if the driver adjusts the driver seat.

2. Discussion of the Related Art

Many modern vehicles include systems for automatically positioning a driver seat and mirrors to a configuration which has been previously defined and stored for a particular driver. These systems can faithfully restore the driver seat and mirrors to a combination of locations and orientations which were previously set and stored by a driver. Some such systems can adjust the driver seat and mirrors to the preferred settings of a driver before the driver even enters the vehicle, by using a remote keyless entry key fob or other identifier to trigger the pre-adjustment. Other systems can configure radio, climate control, and other sub-systems to a driver's preferred settings, in addition to the seat and mirrors.

However, the systems described above all share a fundamental limitation—that is, they can only re-create positions that have been previously set and stored by drivers. The systems known in the art cannot anticipate an optimum configuration of seats and mirrors based upon information about the size of the driver. Nor can the systems known in the art adjust the mirrors and other components to a new optimal configuration in response to a minor adjustment of the driver seat by the driver.

In order to advance the capability of automatic vehicle cockpit adjustment systems, it is necessary to take into account the size of the driver, and use the driver size information in a set of calculations to determine optimal cockpit configuration. A system which can optimally configure itself based on a driver's size would not only be able to pre-adjust for a driver of a known size, but would also be able to adapt to minor adjustments by the driver. Such a system would provide greater convenience for the driver, while enhancing the market appeal of the vehicle for the manufacturer.

### SUMMARY OF THE INVENTION

In accordance with the teachings of the present invention, a method and system are disclosed for automatically adjusting a driver seat, steering wheel, pedals, mirrors, and other components of a vehicle, based on information about the size of the driver. The method uses basic information about the driver's size—including standing height, sitting height, and gender—in a model which estimates all anthropometric data for the driver. The anthropometric data for the driver—including upper and lower arm and leg lengths, torso length, and other dimensions—is used in inverse kinematic calculations to determine optimal positions and orientations for the adjustable components of the vehicle's cockpit. The method then pre-adjusts the components before the driver enters the vehicle, and makes compatible adjustments to the mirrors and other components if the driver adjusts the driver seat.

Additional features of the present invention will become apparent from the following description and appended claims, taken in conjunction with the accompanying drawings.

### BRIEF DESCRIPTION OF THE DRAWINGS

FIG. 1 is an illustration of a self-adjusting vehicle cockpit and driver convenience system;

FIG. 2 is a block diagram of a software system for computing an optimal configuration of cockpit components based on information about a driver and a vehicle;

FIG. 3 is a schematic diagram of an anthropometric model of the driver, showing the various body dimensions which can be estimated if given the driver's standing height, sitting height, and gender;

FIG. 4 is a schematic diagram of a fitting model of the driver in the vehicle cockpit, showing key components and points used in inverse kinematic calculations of cockpit configuration;

FIG. 5 is a flow chart diagram of a process used by the software system of FIG. 2 to compute the optimal configuration of cockpit components based on information about the driver and the vehicle;

FIG. 6 is a schematic diagram of a geometric model used for inverse kinematic calculations of the positions of the lower extremities;

FIG. 7 is a schematic diagram of a geometric model used for inverse kinematic calculations of the positions of the upper extremities; and

FIG. 8 is a flow chart diagram of a process by which the driver and the driver convenience system interact to adjust the configuration of the vehicle's cockpit.

### DETAILED DESCRIPTION OF THE EMBODIMENTS

The following discussion of the embodiments of the invention directed to an individualizable driver convenience system for cockpit configuration is merely exemplary in nature, and is in no way intended to limit the invention or its applications or uses.

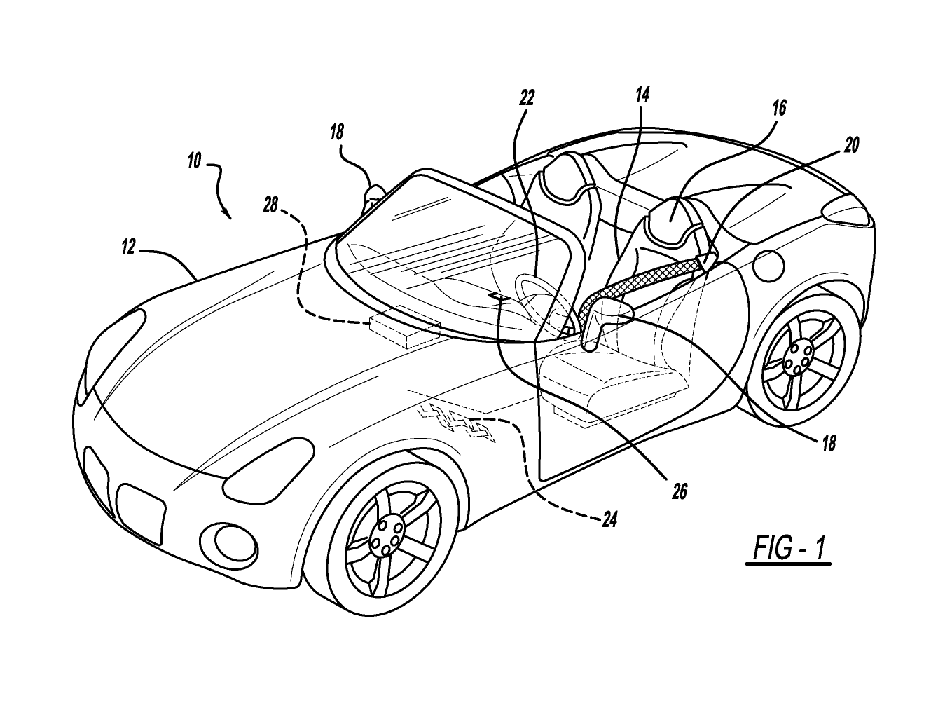

FIG. 1 is an illustration of a self-adjusting vehicle cockpit and driver convenience system 10 on a vehicle 12. The vehicle 12 includes a number of self-adjusting components for driver convenience, including a driver seat 14, a driver headrest 16, outside rearview mirrors 18, a driver shoulder belt height adjuster 20, a steering wheel and column 22, and accelerator and brake pedals 24. An inside rearview mirror (not shown) may also be an adjustable component. A driver recognition and verification sub-system 26 is used to verify the identity of a driver (not shown), by any of several possible means, discussed below. A control module 28 controls the operation of the driver convenience system 10, including computing optimal positions and orientations for each of the components 14-24, and commanding the adjustment of each of the components 14-24 to its optimal position and orientation. The driver convenience system 10 is intended to provide the driver with the convenience and comfort of an ergonomically optimized cockpit configuration, with little or no effort required on the part of the driver.

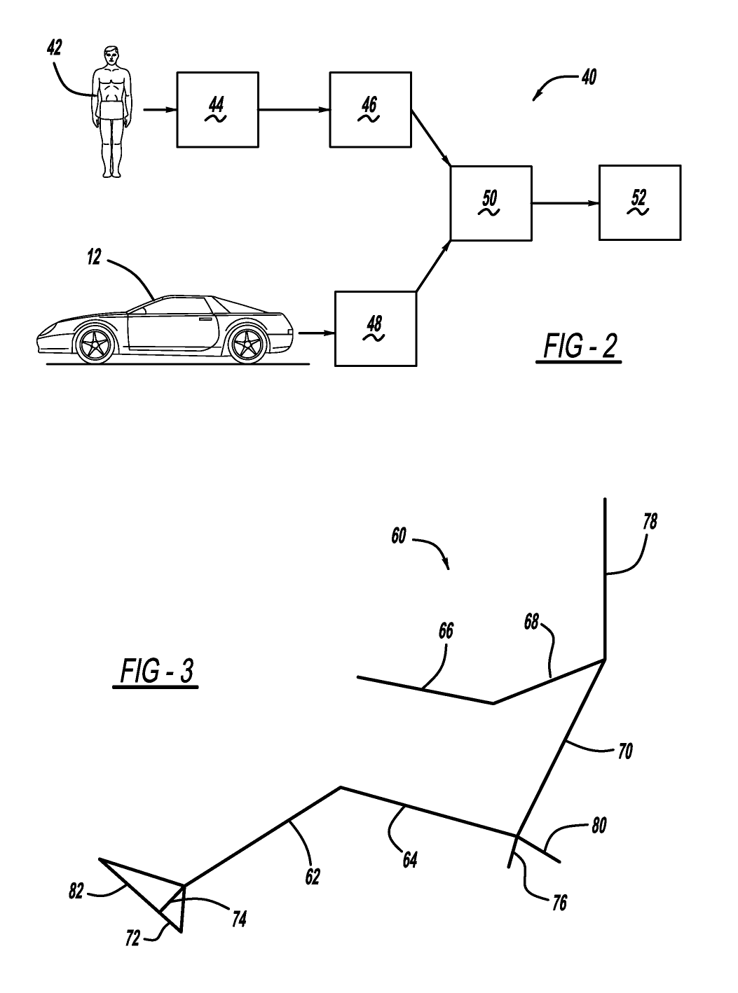

FIG. 2 is a block diagram of a software system 40 used in the driver recognition and verification sub-system 26 and the control module 28, which are in electronic communication with each other. The software system 40 uses information about a driver 42 in a driver identification module 44. The driver identification module 44 can recognize the driver 42 in any of several ways. One way the driver identification module 44 can recognize the driver 42 is through the driver's use of a numbered remote keyless entry key fob device (not shown). If the driver 42 is preliminarily identified via the use of a remote keyless entry key fob device, driver identification will need to be verified at a later step, as sharing of keys and key fobs is a common practice, thus raising the possibility that the driver 42 who is about to enter the vehicle 12 is not the person who is associated with the numbered key fob. The driver identification module 44 could also identify the driver 42 by way of biometric data, which could include fingerprint scanning, iris or retina scanning, facial characteristic recognition, voice pattern recognition, or other methods. Driver identification techniques could also include the driver 42 entering a pass code, either via a keypad or via spoken input. Yet another method of driver identification could be through the recognition of a combination of driver preference settings, such as a driver seat fore-aft location and a radio station setting. The methods described in this paragraph, combinations thereof, and other methods, can be used by the driver identification module 44 to uniquely identify the driver 42 as a specific individual.

Most of the methods described above for the driver identification module 44 to identify the driver 42 require that each person who may be the driver 42 be identified and entered into the driver identification module 44 in advance. However, it is also possible for the driver identification module 44 to provide some basic information about the driver 42, even if the identity of the driver 42 is not able to be ascertained. For example, external sensors could detect the height of the driver 42 as he or she approaches the vehicle 12. Internal sensors could detect the sitting height of the driver 42 after he or she has sat down in the driver seat 14. Voice pattern analysis, facial feature scanning, or other techniques could be used to determine the gender of the driver 42. Determination of standing height, sitting height, and gender by the driver identification module 44 would allow the software system 40 to function even without knowing the specific identity of the driver 42.

An anthropometric estimator module 46 receives attributes of the driver 42, including standing height, sitting height, and gender, from the driver identification module 44. As discussed above, these attributes could be obtained from a driver database once the identity of the driver 42 has been ascertained, or the attributes could be determined by onboard sensors in lieu of a positive driver identification. The anthropometric estimator module 46 uses a human body dimension database, such as the well-known Dreyfuss database, to estimate specific dimensions of the driver 42, as is discussed below.

FIG. 3 is a schematic diagram of an anthropometric model 60 of the driver 42, showing the various body dimensions which can be estimated if given the driver's standing height, sitting height, and gender. Table 1 is an index of the dimensions shown in the anthropometric model 60, including reference numbers, anthropometric model variable numbers, and descriptions.

TABLE 1

| | | Anthro. | |
|---|---|---|---|
| Ref | | Model | |
| # | Dimension | Var. # | Description |
| 62 | l₁ | AM1 | Lower leg, distance from ankle to knee |
| 64 | l₂ | AM2 | Upper leg, distance from knee to hip joint |
| 66 | e₁ | AM3 | Lower arm, distance from palm to elbow |
| 68 | e₂ | AM4 | Upper arm, distance from shoulder joint to |
| | | | elbow |
| 70 | t₁ | AM5 | Torso, distance from shoulder joint to hip |
| | | | joint |
| 72 | f₁ | AM6 | Projected distance from ankle to heel |
| 74 | f₂ | AM7 | Ankle height, vertical distance from ankle to |
| | | | floor |
| 76 | f₃ | AM8 | Buttock vertical thickness, from hip to |
| | | | buttocks |
| 78 | f₄ | AM9 | Shoulder joint to T-vertex (top of head) |
| 80 | f₅ | AM10 | Buttock horizontal thickness, from hip to |
| | | | buttocks |
| 82 | f₆ | AM11 | Projected distance from ankle to ball of foot |

The anthropometric estimator module 46 resolves all anthropometric model variables, AM1-AM11, given the height, sitting height, and gender of the driver 42. Details of this are discussed below.

Continuing the discussion of the software system 40 in FIG. 2, a vehicle data module 48 provides key dimensional data about the vehicle 12. The dimensional data about the vehicle 12 from the vehicle data module 48, along with the anthropometric data about the driver 42 from the anthropometric estimator module 46, are used in an inverse kinematic calculation module 50.

Table 2 lists the data about the vehicle 12 which is provided by the vehicle data module 48, including the vehicle model variable number and the description for each item.

TABLE 2

| Vehicle | |
|---|---|
| Model | |
| Var. # | Description |
| V1 | Steering wheel pivot |
| V2 | Steering wheel diameter |
| V3 | Steering wheel center |
| V4 | Steering wheel tilt angle range |
| V5 | Seat cushion foremost point |
| V6 | Seat cushion rearmost point |
| V7 | Seat cushion vertical range |
| V8 | Seat cushion angle range |
| V9 | Headrest lowest point |
| V10 | Headrest highest point |
| V11 | Headrest curvature |
| V12 | Headrest elevation range |
| V13 | Seat back lowest point |
| V14 | Seat back highest point |
| V15 | Seat back angle range |
| V16 | Pedal reference point |
| V17 | Accelerator heel point |
| V18 | Head liner height |
| V19 | Knee bolster line |

The data items V1-V19 provided by the vehicle data module 48 include numeric values, such as V2 (Steering wheel diameter); points, such as V9 (Headrest lowest point); and lines, such as V19 (Knee bolster line). This data provides sufficient definition of the cockpit environment to allow optimal fitting of the driver 42 with the driver seat 14 and other adjustable components of the cockpit. The data items V1-V19 about the vehicle 12 are used in the inverse kinematic calculation module 50, and subsequently used for component adjustments.

Returning to discussion of the software system 40 of FIG. 2, the inverse kinematic calculation module 50 calculates positions of the driver seat 14, outside rearview mirrors 18, pedals 24, steering wheel and column 22, and other components which provide optimum comfort and safety for the driver 42. These calculations are based on the anthropometric model data, AM1-AM11, and the vehicle data, V1-V19, as discussed above. The details of the calculations performed in the inverse kinematic calculation module 50 will be provided below. Finally in the software system 40, the outputs of the inverse kinematic calculation module 50 are provided to an adjustment command module 52, which commands each of the adjustable components to move to the position and orientation computed by the inverse kinematic calculation module 50.

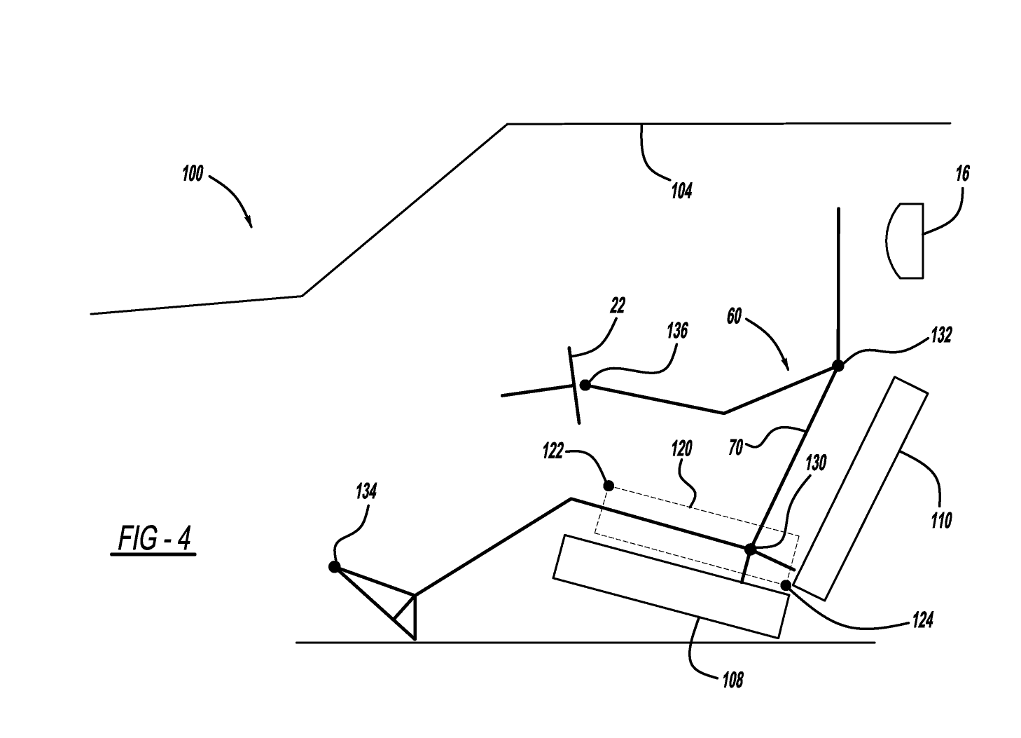

FIG. 4 is a schematic diagram of a fitting model 100 which is used to optimally fit the anthropometric model 60 of the driver 42 in the vehicle cockpit. The fitting model 100 in FIG. 4 shows key components and points used in inverse kinematic calculations of cockpit configuration, which will be discussed below.

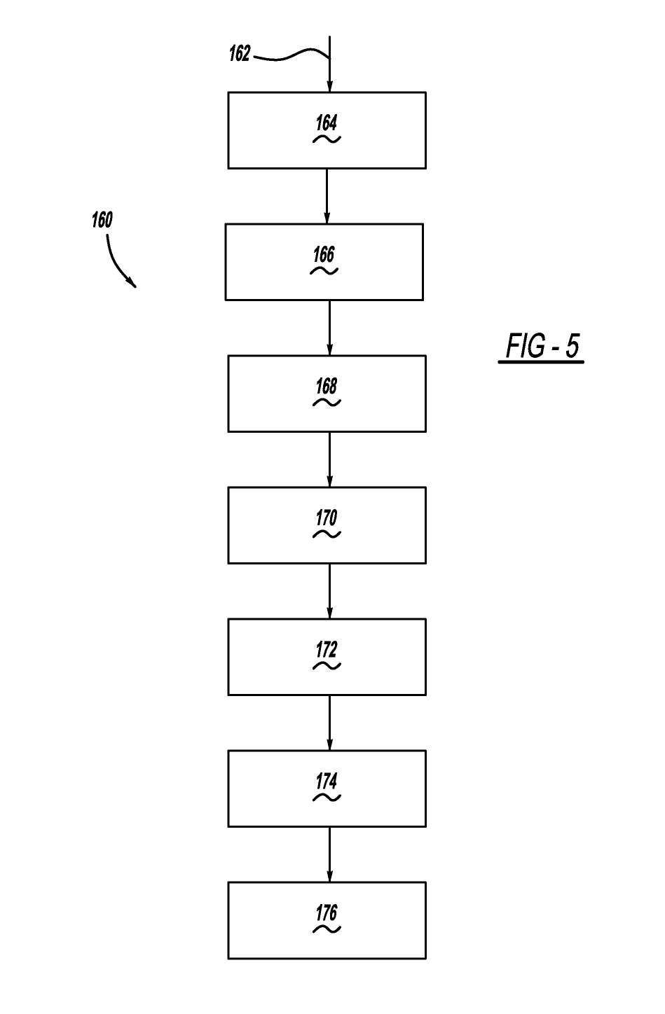

FIG. 5 is a flow chart diagram 160 of a process used by the anthropometric estimator module 46 and the inverse kinematic calculation module 50 of the software system 40. The process begins with provision of the height, sitting height, and gender of the driver 42 on line 162. At box 164, the anthropometric model data items, AM1-AM11, are estimated using the anthropometric estimator module 46. Following is a detailed explanation of the calculations in the anthropometric estimator module 46.

Based on the height (h), sitting height (sh), and gender (i=0 for male, i=1 for female) of the driver 42, and the order of the estimator (order=1 for linear estimation, order=2 for quadratic estimation), the anthropometric model variables AM1-AM11 (also known as l₁, l₂, e₁, etc.) can be estimated using either a linear or quadratic function. First, the driver's size is interpolated in terms of the Dreyfuss database, which includes the following data for individuals of median and extreme size (height h and sitting height sh values are in millimeters):

h = 1476; sh = 782; i = 1; for 1^{st} percentile female
h = 1626; sh = 859; i = 1; for 50^{th} percentile female
h = 1774; sh = 994; i = 1; for 99^{th} percentile female
h = 1590; sh = 831; i = 0; for 1^{st} percentile male
h = 1755; sh = 914; i = 0; for 50^{th} percentile male
h = 1920; sh = 999; i = 0; for 99^{th} percentile male

Using the above ranges, via a least squared linear fit to the data for the driver 42, the first order anthropometric estimators are given by the vector F, where F=Q1*[h1]′. [h1]′ is a column vector, and the matrix Q1 is defined as:

$$Q 1 = [ \begin{matrix}0.0455 & - 16.1061 \\ 0.0671 & - 52.4633 \\ 0.0848 & - 68.5758 \\ 0.0671 & - 35.0811 \\ 0.0939 & - 81.8636 \\ 0.1343 & - 138.5444 \\ 0.1152 & 161.9091 \\ 0.1477 & 104.3304 \\ 0.0939 & - 44.5303 \\ 0.1007 & - 45.0771 \\ 0.1545 & - 80.5606 \\ 0.2146 & - 167.8400 \\ 0.0788 & - 86.6061 \\ 0.0139 & - 117.2749 \\ 0.1667 & 38.8333 \\ 0.1879 & - 1.8093 \\ 0.2 & - 72 \\ 0.1511 & 13.3844\end{matrix} ]$$

The anthropometric model variables AM1-AM11 are then obtained from the vector F as follows:

AM6=f₁=F(1+i)

AM7=f₂=F(3+i)

AM8=f₃=0.9*F(5+i)

AM9=f₄=F(7+i)

AM10=f₅=F(9+i)

AM11=f₆=F(11+i)

AM3=e₁=F(15+i)

AM4=e₂=F(17+i)

AM1=l₁=(h−sh+f₃−f₂)/2

AM2=l₂=l₁

AM5=t₁=sh−f₃−f₄

Where, for example F(1+i) represents the element 1+i from the vector F, and h, sh, and i have been defined above.

In a similar way, a second order anthropometric estimator can be used. Using the Dreyfuss percentile data given above, via a least squared quadratic fit to the data for the size of the driver 42, the second order anthropometric estimators are given by the vector F, where F=Q2*[h²h1]′. [h²h1]′ is a column vector, and the matrix Q2 is defined as:

$$Q 2 = [ \begin{matrix}- 1.836550 e - 5 & 0.1099 & - 72.3388 \\ - 8.706693 e - 5 & 0.3501 & - 281.0385 \\ - 3.673095 e - 5 & 0.2138 & - 181.0413 \\ 3.023160 e - 6 & 0.0573 & - 27.1445 \\ - 1.652893 e - 4 & 0.6741 & - 587.9587 \\ - 8.404378 e - 5 & 0.4074 & - 359.1830 \\ - 2.203857 e - 4 & 0.8887 & - 512.8843 \\ - 3.8394 e - 5 & 0.2724 & 3.5351 \\ - 9.182736 e - 5 & 0.4163 & - 325.6942 \\ - 2.206905 e - 4 & 0.8179 & - 624.4519 \\ - 1.836547 e - 5 & 0.2190 & - 136.7934 \\ 4.150795 e - 4 & - 1.1342 & 921.8609 \\ - 7.346189 e - 5 & 0.3366 & - 311.5372 \\ 2.524336 e - 4 & - 0.7164 & 545.4347 \\ - 9.182736 e - 5 & 0.4889 & - 242.3306 \\ - 8.162525 e - 5 & 0.4532 & - 216.0986 \\ - 1.25091 e - 18 & 0.2 & - 72 \\ - 0.0003310357 & 1.2268 & - 855.6778\end{matrix} ]$$

The anthropometric model variables AM1-AM11 are then obtained from the vector F as before for the linear estimator; that is:

AM6=f₁=F(1+i)

AM7=f₂=F(3+i)

AM8=f₃=0.9*F(5+i)

AM9=f₄=F(7+i)

AM10=f₅=F(9+i)

AM11=f₆=F(11+i)

AM3=e₁=F(15+i)

AM4=e₂=F(17+i)

AM1=l₁=(h−sh+f₃−f₂)/2

AM2=l₂=l₁

AM5=t₁=sh−f₃−f₄

Using either the linear or quadratic anthropometric estimator, the anthropometric model variables AM1-AM11 (l₁, l₂, e₁, etc.) can be calculated. These quantities will be used in calculations later in the process.

At box 166, a first set of fitting calculations are performed. The calculations at the box 166 resolve torso orientation as a function of the driver's sitting height. These calculations are designed to attempt to maintain a torso angle q at an optimal value for comfort, while ensuring that the driver 42 will fit within the height constraints of the vehicle 12. The torso angle q is defined as the angle between the vertical and a line from hip joint center 130 to shoulder joint 132. First, the torso angle q is set to a value of 27 degrees according to postural comfort recommendations. When moving the seat 14 in all directions and all possible combinations, the estimated location of the hip joint center 130 will draw a hip joint center (HJC) travel box 120. Then a distance Dₘᵢₙ can be defined as the perpendicular distance from a highest corner 122 of the HJC travel box 120 to headliner 104. And a distance Dₘₐₓ can be defined as the perpendicular distance from a lowest corner 124 of the HJC travel box 120 to the headliner 104.

Next, a distance d, representing the sitting height of the driver 42 minus the height of the hip joint center 130, when accounting for seat configuration, is defined as follows:

$$d = {f}_{4} + {t}_{1} * cos ( q * \frac{π}{180} ) \qquad ( 1 )$$

Where f₄ and t₁ are dimensions from the anthropometric data calculated at the box 164, and q is the torso angle in degrees.

If d is greater than Dₘₐₓ, then the driver 42 has a long torso, and seat back 110 will have to be reclined at an angle greater than the original angle q. In this case, a new value for q can be computed as:

$$q = \frac{180}{π} * {cos}^{- 1} ( \frac{{D}_{ma x} - {f}_{4} - {f}_{3} * sin ( ( 90 - p ) * \frac{π}{180} )}{{t}_{1}} ) \qquad ( 2 )$$

Where f₃ is a dimension from the anthropometric data calculated at the box 164, p is the angle in degrees of seat cushion 108 from horizontal, and the other variables have been defined above. The target value of p is 15 degrees for optimum comfort.

If d is less than Dₘᵢₙ, then the driver's torso is short and fits at any recline angle, so the original 27° value for the angle q can be maintained for comfort. Also, in the case of a short torso, the seat cushion 108 may need to be raised in order to position the driver's head at the proper height. If d is greater than Dₘᵢₙ but less than Dₘₐₓ, then the driver 42 is considered to have a medium torso, and the torso angle q could possibly be kept at the original comfort value, depending on arm reach to the steering wheel and column 22 and leg reach to the pedals 24. In this case, arm and leg reach and torso angle are calculated simultaneously, as described below.

When the calculations of the box 166 are completed, the angle of the seat back 110 is set equal to the torso angle q. At box 168, inverse kinematic calculations are performed to position the lower extremities, and define the fore-aft position of the driver seat 14. Pedal fore-aft position can also be defined at the box 168 if the pedals 24 are adjustable. The calculations of the box 168 are designed to target small deviations, if any, from knee and ankle angles which are optimal for comfort, while also maintaining the torso angle q as close as possible to the optimal comfort value.

In general, forward kinematics refers to calculations where the lengths and angles of the elements of a mechanism are known, and the position of one element end relative to another needs to be calculated. Conversely, inverse kinematics refers to calculations where the lengths of the elements, and the position of one element end relative to another are known, and the angles need to be calculated. For example, in positioning of the lower extremities, the ball of the driver's foot has to reach the pedals 24, and the driver's hip joint (adjusted for buttock thickness) has to be on the seat 14. Given this scenario, inverse kinematics can be used to compute hip, knee, and ankle angles. Following are the details of the inverse kinematic calculations of the box 168.

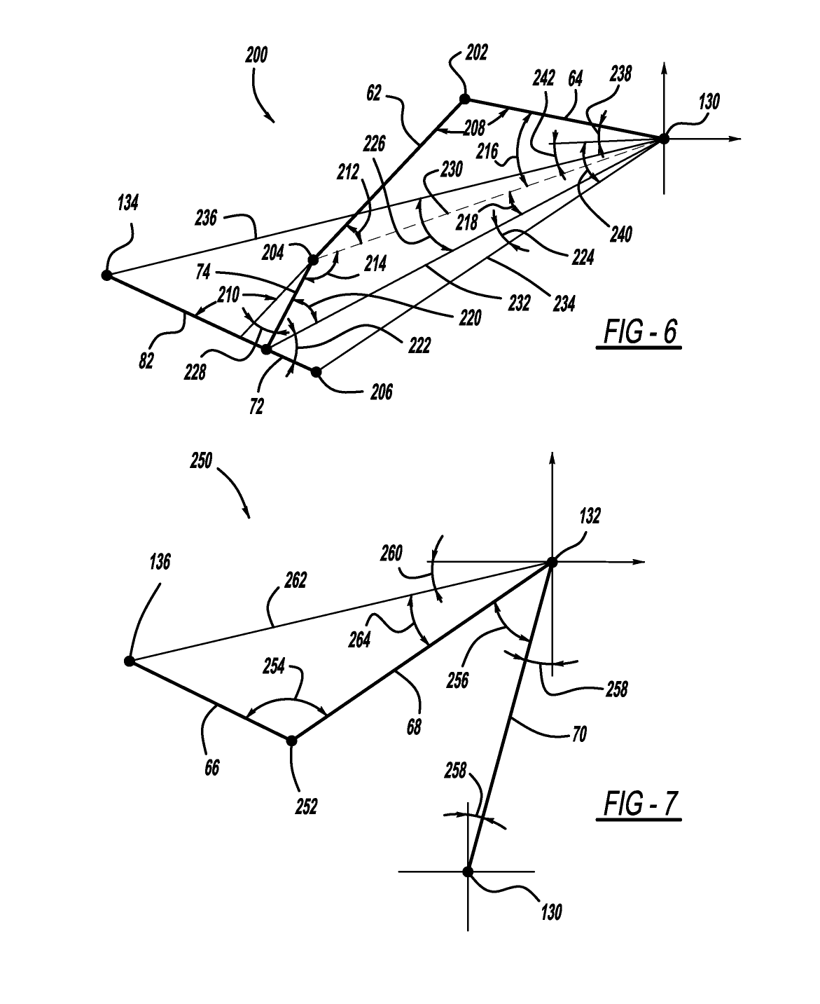

FIG. 6 is a schematic diagram of a geometric model 200 used for inverse kinematic calculations of the positions of the lower extremities. Table 3 is an index of the elements, dimensions, angles, and points shown in the geometric model 200, including reference numbers, and descriptions.

TABLE 3

| Ref # | Dimension | Description |
|---|---|---|
| 62 | l₁ | Lower leg, distance from ankle to knee |
| 64 | l₂ | Upper leg, distance from knee to hip joint |
| 72 | f₁ | Projected distance from ankle to heel |
| 74 | f₂ | Ankle height, vertical distance from ankle to floor |
| 82 | f₆ | Projected distance from ankle to ball of foot |
| 130 | n/a | Hip joint |
| 134 | n/a | Ball of foot |
| 202 | n/a | Knee joint |
| 204 | n/a | Ankle joint |
| 206 | n/a | Heel point |
| 208 | knee | Knee angle |
| 210 | ankle | Ankle angle |
| 212 | A₁ | An angle used in the inverse kinematic calculations |
| 214 | A₂ | An angle used in the inverse kinematic calculations |
| 216 | A₃ | An angle used in the inverse kinematic calculations |
| 218 | A₄ | An angle used in the inverse kinematic calculations |
| 220 | A₅ | An angle used in the inverse kinematic calculations |
| 222 | A₆ | An angle used in the inverse kinematic calculations |
| 224 | A₇ | An angle used in the inverse kinematic calculations |
| 226 | A₈ | An angle used in the inverse kinematic calculations |
| 228 | γ | An angle used in the inverse kinematic calculations |
| 230 | a₁ | Distance from hip joint 130 to ankle joint 204 |
| 232 | a₂ | Distance from hip joint 130 to ground projection of |
| | | ankle joint 204 |
| 234 | a₃ | Distance from hip joint 130 to heel 206 |
| 236 | a₆ | Distance from hip joint 130 to ball of foot 134 |
| 238 | p | Angle of seat cushion 108 from horizontal |
| 240 | p₃ | An angle used in the inverse kinematic calculations |
| 242 | p₆ | An angle used in the inverse kinematic calculations |

First, equations are defined for the location of the hip joint 130 relative to the ball of foot 134. For all torso lengths (short, medium, long), the equation for the longitudinal location of the hip joint is given by:

$${x}_{h} = {a}_{6} cos ( {p}_{6} \cdot \frac{π}{180} ) \qquad ( 3 )$$

For a short torso, the equation for the vertical location of the hip joint is given by:

$${y}_{h} = {a}_{3} sin ( {p}_{3} \cdot \frac{π}{180} ) \qquad ( 4 )$$

While for a medium or long torso, the equation for the vertical location of the hip joint is given by:

$${y}_{h} = 1025 - {f}_{4} - {t}_{1} cos ( q \cdot \frac{π}{180} ) \qquad ( 5 )$$

Where xₕ and yₕ are the x and y coordinates of the hip joint 130 relative to the ball of foot 134, 1025 is a representative value for the head liner height V18, f₄, t₁, and q were defined above, and the angles p₃ and p₆ will be solved for subsequently. Equations (3)-(5) describe the overall seating position of the driver 42 relative to the pedals 24.

Next, the horizontal and vertical seat positions are defined in terms of the hip joint location and other factors. The horizontal seat position tₙ is normalized to a value between 0 and 1, where 0 is the fully forward position and 1 is the fully aft position. The vertical seat position dₙ is also normalized to a value between 0 and 1, where 0 is the fully downward position and 1 is the fully upward position. The horizontal and vertical seat positions are governed by equations that consider constraints including the driver's foot being on the pedals, the fit of the torso, the driver's hands on the wheel of the steering wheel and column 22, and knee bolster clearance. The horizontal seat position is defined as:

tₙ=max{0,min [1,(track)]} (6)

### Where

$$track = \frac{( {x}_{h} + {f}_{5} \cdot cos ( q \cdot \frac{π}{180} ) - \frac{{y}_{h} - {f}_{5} \cdot sin ( q \cdot \frac{π}{180} ) - 150.65}{tan ( ( 90 - q ) \frac{π}{180} ) - 908.1} )}{( \frac{213.2 \cdot sin ( sta \cdot \frac{π}{180} )}{tan ( ( 90 - q ) \cdot \frac{π}{180} )} + 213.2 cos ( sta \cdot \frac{π}{180} ) )} .$$

The vertical seat position is defined as:

$${d}_{n} = max \{ 0 , min [ 1 , \frac{Numer}{Denomin} ] \} \qquad ( 7 )$$

### Where

$$Numer = {y}_{h} - {f}_{3} \cdot sin ( ( 90 - p ) \cdot \frac{π}{180} ) + 0.2322 [ {x}_{h} - {f}_{3} \cdot cos ( ( 90 - p ) \cdot \frac{π}{180} ) - 901.1054 - 213.2 \cdot track \cdot cos ( sta \cdot \frac{π}{180} ) ] + 213.2 \cdot track \cdot sin ( sta \cdot \frac{π}{180} ) - 132.5152 , \\ Denomin = - ( 0.2322 ) ( 54.7 ) sin ( dta \cdot \frac{π}{180} ) + 54.7 cos ( dta \cdot \frac{π}{180} ) ,$$

sta is the seat track angle above horizontal, and dta is the cushion rise angle from vertical. In the case of a long torso, the vertical seat position dₙ is set to 0, that is, the seat is all the way down to maximize vertical space for the driver.

Equations (3)-(7) above define the basic framework of fore-aft and vertical positions of the hip joint and seat, in terms of the angles p₃ and p₆ and other variables. Inverse kinematics can now be used to compute the internal angles, including p₃ and p₆, in the geometric model 200 of FIG. 6. Using inverse kinematics to solve for p₃ and p₆ will allow for the calculation of the seat and lower body positions.

Referring to the geometric model 200, the cosine law can be used to define the following equations:

a₁²=l₁²+l₁l₂ cos(knee) (8)

l₂²=l₁²+a₁²−2l₁a₁ cos Aₗ (9)

### Therefore:

$$cos {A}_{1} = \frac{{l}_{1}^{2} + {a}_{1}^{2} - {l}_{2}^{2}}{2 {l}_{1} {a}_{1}} \qquad ( 10 )$$

### And:

A₂=180°−γ−A₁ (11)

The cosine law can again be used to define the following equations:

a₂²=f₂²+a₁²−2f₂a₁ cos A₂ (12)

a₁²=a₂²+f₂²−2f₂a₂ cos A₅ (13)

### Therefore:

$$cos {A}_{5} = \frac{{f}_{2}^{2} + {a}_{2}^{2} - {a}_{1}^{2}}{2 {f}_{2} {a}_{2}} \qquad ( 14 )$$

### And:

A₆=90°−A₅ (15)

Continuing through the geometric model 200, the cosine law can again be used to define the following:

a₃²=f₁²+a₂²−2f₁a₂ cos A₆ (16)

a₆²=f₆²+a₂²−2f₆a₂ cos(A₅+90) (17)

The following equation allows the calculation of angle A₃:

A₃=180°−A₁−knee (18)

Then the cosine law can again be used to define the following:

f₂²=a₁²+a₂²−2a₁a₂ cos A₄ (19)

f₁²=a₂²+a₃²−2a₂a₃ cos A₇ (20)

Which leads to:

$$\begin{matrix}cos {A}_{4} = \frac{{a}_{1}^{2} + {a}_{2}^{2} - {f}_{2}^{2}}{2 {a}_{1} {a}_{2}} & ( 21 ) \\ cos {A}_{7} = \frac{{a}_{2}^{2} + {a}_{3}^{2} - {f}_{1}^{2}}{2 {a}_{2} {a}_{3}} & ( 22 )\end{matrix}$$

### Then:

p₃=A₃+A₄+A₇−p (23)

The location of the heel point 206 can then be calculated as:

x₃=−a₃ cos p₃ (24)

y₃=−a₃ sin p₃ (25)

And substituting from Equation (4):

yₕ=−y₃ (26)

The cosine law can be used once more to define:

f₆²=a₂²+a₆²−2a₂a₆ cos A₈ (27)

### Therefore:

$$cos {A}_{8} = \frac{{a}_{2}^{2} + {a}_{6}^{2} - {f}_{6}^{2}}{2 {a}_{2} {a}_{6}} \qquad ( 28 )$$

### Then:

p₆=A₃+A₄−A₈−p (29)

The location of the ball of foot point 134 can then be calculated as:

x₆=a₆ cos p₆ (30)

y₆=−a₆ sin p₆ (31)

And substituting from Equation (3):

xₕ=−x₆ (32)

Solution of the above equations is possible if the knee and ankle angles are known. Postural comfort guidelines dictate a target knee angle of 135 degrees, and a target ankle angle of 103 degrees. These values are used in the inverse kinematic calculations detailed above, and if the location of the driver seat 14 relative to the pedals 24 is too great (exceeds the travel limits of the driver seat 14), then the knee and ankle angles can be modified to accommodate the driver's leg size with the maximum available distance between the driver seat 14 and the pedals 24.

The above calculations performed at the box 168, including Equations (1)-(32), fully resolve the geometric model 200. This defines the location of the hip joint 130, the ankle, knee, and hip angles, the fore-aft and vertical positions of the driver seat 14, and the tilt angles of the seat cushion 108 and the seat back 110. If the pedals 24 in the vehicle 12 are adjustable, pedal fore-aft position can be included in the calculations of the box 168, thus allowing the position of the ball of foot point 134 to be moved, and allowing greater flexibility to meet the ankle, knee, and torso angles dictated by postural comfort guidelines.

At box 170, inverse kinematic calculations are performed to position the upper extremities, and define the steering wheel position. These calculations are designed to target small deviations, if any, from shoulder and elbow angles which are optimal for comfort.

FIG. 7 is a schematic diagram of a geometric model 250 used for inverse kinematic calculations of the positions of the upper extremities. Table 4 is an index of the elements, dimensions, angles, and points shown in the geometric model 250, including reference numbers, and descriptions.

TABLE 4

| Ref # | Dimension | Description |
|---|---|---|
| 66 | e₁ | Lower arm, distance from palm to elbow |
| 68 | e₂ | Upper arm, distance from shoulder joint to elbow |
| 70 | t₁ | Torso, distance from shoulder joint to hip joint |
| 130 | n/a | Hip joint |
| 132 | n/a | Shoulder joint |
| 136 | n/a | Palm joint |
| 252 | n/a | Elbow joint |
| 254 | elbow | Elbow angle |
| 256 | shoulder | Shoulder angle |
| 258 | q | Torso angle |
| 260 | q′ | Angle below horizontal of palm-shoulder line |
| 262 | b | Distance from shoulder to palm |
| 264 | B₁ | An angle used in the inverse kinematic calculations |

The calculations at the box 170 begin with geometric relationships for the palm joint 136 relative to the shoulder joint 132; from basic trigonometry and the Pythagorean theorem:

$$tan {q}^{′} = \frac{{y}_{s} - {y}_{p}}{{x}_{s} - {x}_{p}} \qquad ( 33 )$$

b²=(xₛ−xₚ)²+(yₛ−yₚ)² (34)

Where (xₛ, yₛ) and (xₚ, yₚ) are the coordinates of the shoulder joint 132 and the palm joint 136, respectively.

Then the cosine law can be used to define:

b²=e₁²+e₂²−2e₁e₂ cos(elbow) (35)

### Therefore:

$$cos ( elbow ) = \frac{{e}_{1}^{2} + {e}_{2}^{2} - {b}^{2}}{2 {e}_{1} {e}_{2}} \qquad ( 36 )$$

Then the elbow angle can be solved for as:

$$elbow = {cos}^{- 1} ( \frac{{e}_{1}^{2} + {e}_{2}^{2} - {b}^{2}}{2 {e}_{1} {e}_{2}} ) \qquad ( 37 )$$

The cosine law also yields:

$$cos {B}_{1} = \frac{{b}^{2} + {e}_{2}^{2} - {e}_{1}^{2}}{2 {e}_{2} b} \qquad ( 38 )$$

And by definition:

q′+B₁+q+shoulder=90 (39)

Therefore the shoulder angle can be computed as:

shoulder=90−q−q′−B₁ (40)

The above calculations performed at the box 170, including Equations (33)-(40), fully resolve the geometric model 250. This defines the location of the shoulder joint 132, and the shoulder and elbow angles. If the steering wheel and column 22 in the vehicle 12 is adjustable, steering wheel fore-aft position can be included in the calculations of the box 170, thus allowing the position of the shoulder joint 132 to be moved if necessary to meet the torso angle dictated by postural comfort guidelines.

At box 172, a calculation of headrest elevation is made, such that the headrest 16 is positioned properly behind the driver's head. This calculation simply places the headrest 16 at an optimal location based on the sitting height of the driver 42. At box 174, a calculation is made to position the shoulder belt height adjuster 20 at the proper height. This is a simple calculation based on the seat vertical position and the driver's torso length t₁. And at box 176, the orientations of the outside rearview mirrors 18 are calculated, such that the mirrors 18 will be properly positioned based on the now-known location of the driver's head. This calculation defines a first line from the driver's head to the center of each of the outside rearview mirrors 18, computes a second line through the center of each of the outside rearview mirrors 18 and parallel to the vehicle centerline, bisects the angle between the first and second line, and uses the bisection line to define the normal to the outside rearview mirror 18.

In summary, the process shown in the flow chart diagram 160 uses the driver's height, sitting height, and gender as input, estimates a complete set of anthropometric dimensions for the driver 42, and calculates optimal positions for all adjustable components in the vehicle 12.

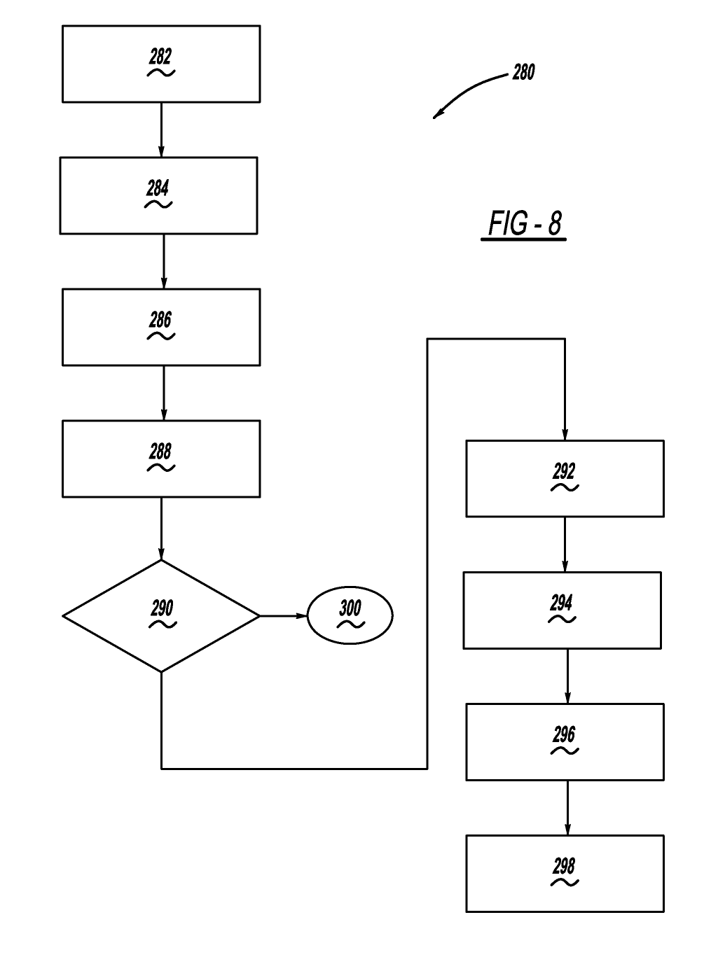

FIG. 8 is a flow chart diagram 280 of a process by which the driver 42 and the driver convenience system 10 interact to adjust the configuration of the vehicle's cockpit. At box 282, a person approaches the vehicle 12 and activates a key fob to unlock the doors. From this point on, the person is considered to be the driver 42. At box 284, the driver convenience system 10 adjusts the components of the cockpit to the theoretical settings calculated by the software system 40 using the process of the flow chart diagram 160, or to the preferred settings of the driver 42 (if available) who is associated with the key fob which was just activated. At box 286, the driver 42 enters the vehicle 12.

At box 288, the driver 42 re-adjusts the components of the cockpit. If the driver 42 does not re-adjust the components of the cockpit, then it is presumed that the driver 42 is comfortable, and no further action is taken by the driver convenience system 10. If, however, the driver 42 re-adjusts the components of the cockpit within a certain prescribed time after entering the vehicle 12, or the driver 42 sets or resets the interior memory, then the driver recognition and verification sub-system 26 of the driver convenience system 10 will attempt to verify the identity of the driver 42. Verification of the identity of the driver 42 can be accomplished in a number of ways, as described previously in the discussion of the driver identification module 44 of the software system 40.

At decision diamond 290, if the driver recognition and verification sub-system 26 cannot verify the identity of the driver 42, the process ends at terminus oval 300. If the identity of the driver 42 is verified, then the process continues to box 292, where the driver convenience system 10 retrieves the personal profile data of the driver 42 who has been individually identified. At box 294, the driver convenience system 10 memorizes the preferred settings of the individual driver 42 based on the re-adjustments made by the driver 42 at the box 288, and estimates a bias for the individual driver 42. The bias for the individual driver 42 is based on the deviation of the current settings from the theoretical settings, where the theoretical settings are calculated by the software system 40 using the process of the flow chart diagram 160.

At box 296, the driver 42 re-adjusts the driver seat 14 during driving. At box 298, the driver convenience system 10 re-adjusts the outside rearview mirrors 18 and the headrest 16 based on the new seating position of the driver 42, and using the calculations described above for the process of the flow chart diagram 160.

Using the methods and calculations described above, the driver convenience system 10 can use anthropometric data about any driver 42 of the vehicle 12 to optimally position the driver seat 14, the mirrors 18, and other components. This is possible even for individuals who do not have preferences stored in the system's memory, if the driver's height, sitting height, and gender can be determined. The driver convenience system 10 can also adapt to minor seat adjustments made by the driver 42 while driving, thus alleviating the driver 42 from having to re-adjust multiple components. These features provide a level of comfort and convenience which is not available in traditional memory-seat systems.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for automatically adjusting positions of a driver seat and other components of a vehicle, said method comprising:
providing data about an interior space of the vehicle where a driver is seated;
providing a plurality of attributes about the driver;
using the attributes about the driver in an anthropometric estimator to estimate body dimensions for the driver;
using the body dimensions for the driver and the data about the interior space of the vehicle to calculate optimal positions of the driver seat and the other components; and
adjusting the positions of the driver seat and the other components to the optimal positions.

2. The method of claim 1 wherein the positions of the driver seat include seat fore-aft position, seat cushion elevation and recline angle, seat back recline angle, and lumbar support position.

3. The method of claim 1 wherein the other components include a headrest, outside rearview mirrors, an inside rearview mirror, a shoulder belt height adjuster, a steering wheel and column, and accelerator and brake pedals.

4. The method of claim 1 wherein providing a plurality of attributes about the driver includes providing standing height, sitting height, and gender of the driver.

5. The method of claim 1 wherein providing a plurality of attributes about the driver includes first identifying the driver from a database of pre-defined drivers, and looking up the attributes from the database.

6. The method of claim 1 wherein providing a plurality of attributes about the driver includes measuring the attributes with one or more sensors when the driver is unidentified.

7. The method of claim 1 wherein using the attributes about the driver in an anthropometric estimator to estimate body dimensions for the driver includes using the attributes in a first order or second order regression model derived from using an anthropometric database of a general population to estimate the body dimensions.

8. The method of claim 1 wherein using the body dimensions for the driver and the data about the interior space of the vehicle to calculate optimal positions of the driver seat and the other components includes using a set of inverse kinematic calculations.

9. The method of claim 8 wherein using a set of inverse kinematic calculations includes calculating the position of the driver seat, ankle, knee, and hip angles, and leg reach, using lower extremity body dimensions as input.

10. The method of claim 8 wherein using a set of inverse kinematic calculations includes calculating driver elbow and shoulder angles, and arm reach, using upper extremity body dimensions as input.

11. The method of claim 8 wherein using a set of inverse kinematic calculations includes calculating a driver torso angle, and seat back recline angle, using leg reach and arm reach as input.

12. The method of claim 1 further comprising readjusting the other components in response to an adjustment of the driver seat by the driver.

13. A method for automatically adjusting positions of a driver seat and other components of a vehicle, said method comprising:
providing data about an interior space of the vehicle where a driver is seated;
providing a plurality of attributes about the driver, including standing height, sitting height, and gender;
using the attributes about the driver in a first or second order anthropometric estimator model to estimate body dimensions for the driver;
using the body dimensions for the driver and the data about the interior space of the vehicle to calculate optimal positions of the driver seat and the other components;
adjusting the positions of the driver seat and the other components to the optimal positions; and
readjusting the other components in response to an adjustment of the driver seat by the driver.

14. A system for automatically adjusting positions of adjustable components in a vehicle, said adjustable components including a driver seat and one or more of a headrest, outside rearview mirrors, an inside rearview mirror, a shoulder belt height adjuster, a steering wheel and column, and accelerator and brake pedals, said system comprising:
a driver identification sub-system for determining attributes about the driver; and
a controller in communication with the driver identification sub-system and the adjustable components, said controller being configured to receive the attributes about the driver from the driver identification sub-system, estimate body dimensions for the driver, calculate optimal positions of the adjustable components, and command the adjustable components to move to the optimal positions.

15. The system of claim 14 wherein the driver identification sub-system determines the attributes about the driver, including standing height, sitting height, and gender, either by identifying the driver from a database of pre-defined drivers, or by measuring the attributes.

16. The system of claim 14 wherein the controller estimates body dimensions for the driver using an anthropometric estimator module, including a first or second order anthropometric model.

17. The system of claim 14 wherein the controller calculates optimal positions of the adjustable components using an inverse kinematic calculation module.

18. The system of claim 17 wherein the inverse kinematic calculation module in the controller includes a routine for calculating the optimal position of the driver seat, ankle, knee, and hip angles, and leg reach, using lower extremity body dimensions as input.

19. The system of claim 17 wherein the inverse kinematic calculation module in the controller includes a routine for calculating optimal driver elbow and shoulder angles, and arm reach, using upper extremity body dimensions as input.

20. The system of claim 17 wherein the inverse kinematic calculation module in the controller includes a routine for calculating an optimal driver torso angle, and seat back recline angle, using leg reach and arm reach as input.
